(19) United States
(12) Patent Application Publication
(10) Pub. No.: US 2017/0145742 A1
(43) Pub. Date: May 25, 2017

(54) Assembly of a tassel and a wall element for tensioning a control loop of a screen

(71) Applicant: Coulisse B.V., Enter (NL)

(72) Inventor: Wouter Hendriks, Enschede (NL)

(21) Appl. No.: 15/127,768

(22) PCT Filed: Mar. 20, 2015
(86) PCT No.: PCT/NL2015/050183

§ 371 Date: Sep. 20, 2016

(30) Foreign Application Priority Data
Mar. 21, 2014 (NL) 2012488

(51) Int. Cl. E06B 9/326; E06B 9/78; F16H 7/08

(52) U.S. Cl. CPC E06B 9/326; F16H 7/08; E06B 9/78; F16H 2007/0842; E06B 2009/785

(57) ABSTRACT

The present invention provides an alternative for tensioning a control loop of a screen, such as a window covering. The invention provides for this purpose an assembly (1) of a tassel (10) for tensioning a control loop (3) of a screen such as a window covering by means of gravitational force, comprising at least an elongate body and control loop guide means for the control loop, and a wall element (20), this wall element being configured for fixing to a wall and intended for receiving the tassel (10), wherein the tassel and the wall element are configured such that the tassel is enclosed by the wall element during operation and the tassel is substantially movable in the wall element. According to the invention the body is provided on the longitudinal side thereof with a guide slot and the wall element is provided with one or more guide elements, wherein the guide slot and the guide elements are configured for co-action.

Roller blinds, vertical blinds, large pleated blinds, folding blinds, panel curtains and Venetian blinds can often be operated with a control loop. In accordance with new standards, the control loop has to hang tightly along the wall so that situations which are hazardous particularly for children do not occur. Many different control loop tensioners are known in the field, varying from a simple hook to a tensioner with spring which has to be mounted on a fixed object, such as a wall or window frame.

The present invention provides an alternative for tensioning a control loop of a screen, such as a window covering. The invention provides for this purpose an assembly of a tassel for tensioning a control loop of a screen such as a window covering by means of gravitational force, comprising at least an elongate body and control loop guide means for the control loop, and a wall element, this wall element being configured for fixing to a wall and intended for receiving the tassel, wherein the tassel and the wall element are configured such that the tassel is enclosed by the wall element during operation and the tassel is substantially movable in the wall element.

The term ‘control loop of a screen’ includes all conceivable flexible connecting means which are applied in the field of window coverings and are named in the EN13120 standard. According to this standard, the definition of a control loop is as follows: ‘Operating loop’: looped cord, chain, ball chain or similar, the length of which remains constant when the internal blind is operated. Known examples of a control loop are a cord, chain or ball chain.

An assembly according to the preamble of claim 1 is known from U.S. Pat. No. 5,676,188. Using the assembly, the control loop can remain tensioned by the tassel, but the control loop can be raised over at least part of the length of the tassel. This creates slack in the control loop, whereby the screen can be operated easily and also complies with the above stated standards.

The assembly according to the invention is distinguished from the known assembly in that the body is provided on the longitudinal side thereof with a guide slot and the wall element is provided with one or more guide elements, wherein the guide slot and each guide element are configured for co-action. Realized in inventive manner with these technical measures is that the tassel is movable to limited extent relative to the wall element and is also enclosed in the wall element. The assembly according to the invention has an aesthetic design. The tassel appears unchanged to the eye and the guide element remains concealed from view. The wall element can moreover take a compact form. In addition, these measures prevent the tassel being able to rotate around its longitudinal axis, whereby the control loop connected to the tassel cannot twist during operation.

The tassel is preferably movable in the wall element over a portion of the body. The tassel and the wall element are configured for this purpose to guide at least a part of the body. The guide slot extends in longitudinal direction over a part of the body of the tassel. The length of the guide slot determines the movement of the tassel.

In a practical preferred embodiment of the assembly according to the invention the wall element is provided with two or more guide elements, which are preferably embodied as protrusions.

In an elegant preferred embodiment of the assembly according to the invention the wall element is provided with one guide element which is preferably generally spherical.

In a further preferred embodiment of the assembly according to the invention the wall element is provided with an opening, the peripheral shape of which substantially corresponds at least partially to the peripheral shape of the body, wherein the body is received in the opening during operation of the assembly. In order to prevent the body being able to rotate along the longitudinal side the guide element is preferably arranged in the opening. The tassel is hereby movable relative to the wall element over at least a part of the body with corresponding peripheral shape.

In order to realize the preferred embodiments the body can have a cylindrical shape. The body can however also have a conical shape, or have another tapering shape.

In each of the preferred embodiments the tassel is preferably provided with a limiting element which is formed such that during operation of the assembly the limiting element limits the movement of the tassel in the wall element. The limiting element is preferably releasably mountable on the tassel here, whereby the tassel can be arranged in simple manner in the wall element.

The limiting element preferably forms the underside of the tassel, so that the limiting element as a whole forms the base for the tassel.

In order to prevent the tassel producing noise during operation when the control loop is operated, the guide slot and/or the guide element are provided with a sound-damping material.

It is undesirable for the control loop to be rotated out of its plane. In order to prevent this the control loop guide means in the assembly according to the invention are provided with a passage intended for throughfeed of the control loop in a throughfeed direction, and the angle between the throughfeed direction and the wall element is adjustable during mounting of the assembly. The control loop guide means are preferably adjustable for this purpose by means of rotation thereof relative to the body, for instance by rotation of the control loop guide means relative to the body.

The invention will be further elucidated with reference to the following figures, in which:

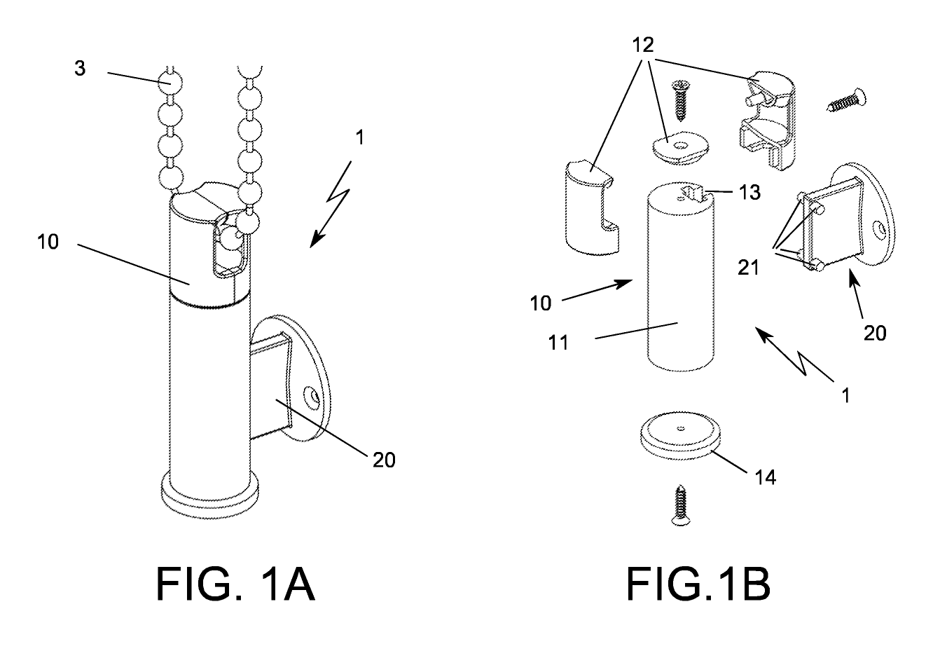

FIG. 1A is an isometric view of the first preferred embodiment of the assembly according to the invention in operation;

FIG. 1B is an exploded view of the first preferred embodiment of the assembly according to FIG. 1A;

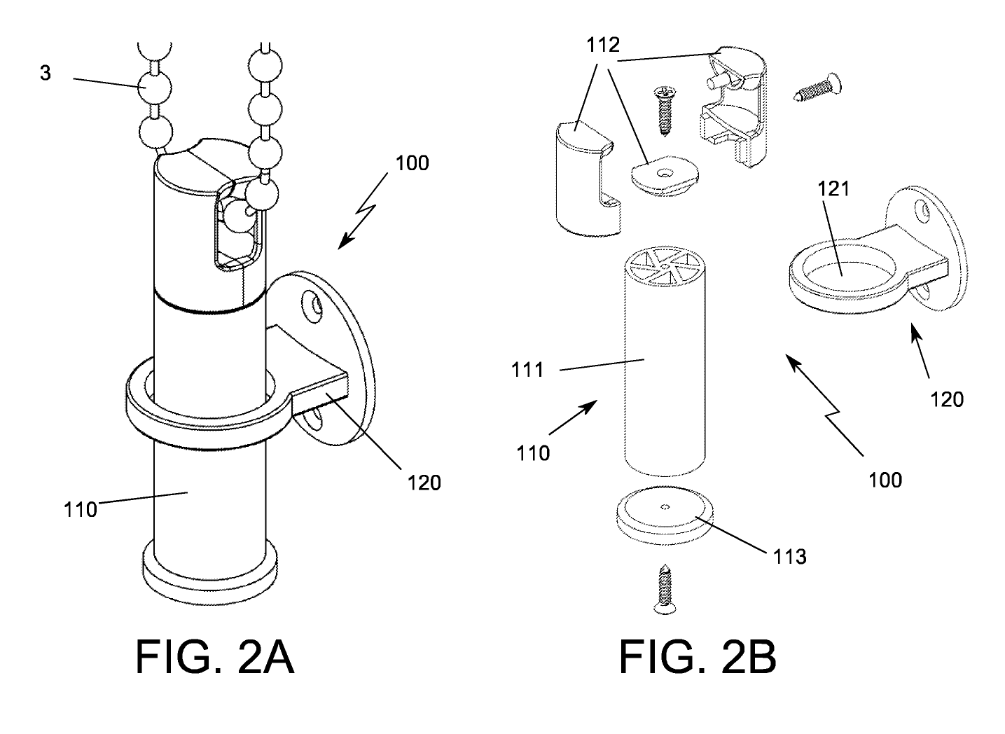

FIG. 2A is an isometric view of the second preferred embodiment of the assembly according to the invention in operation;

FIG. 2B is an exploded view of the second preferred embodiment of the assembly according to the invention according to FIG. 2A;

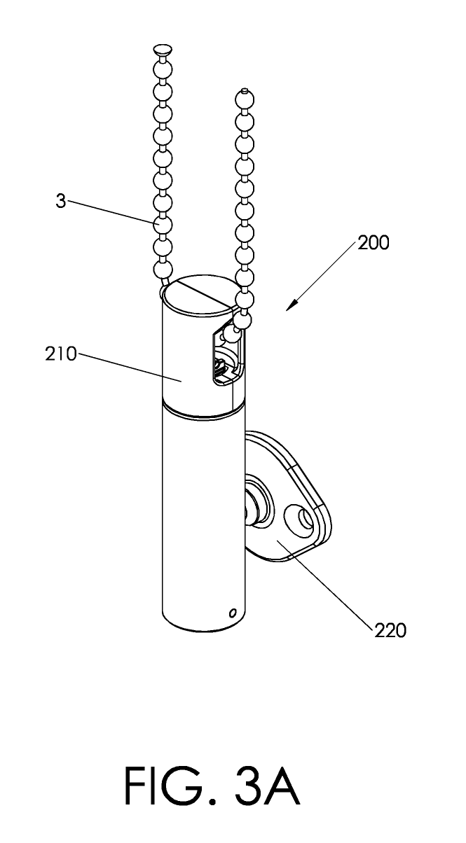

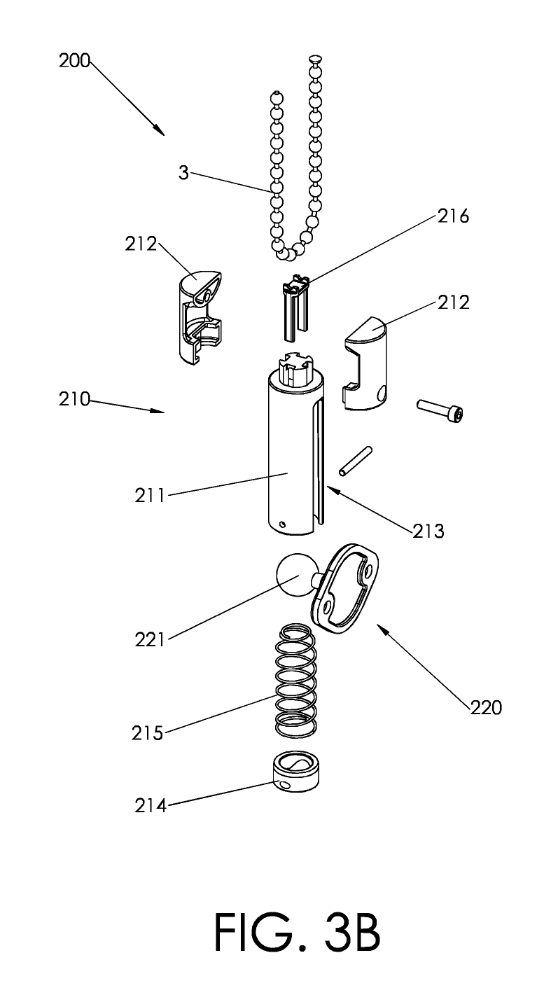

FIG. 3A is an isometric view of the third preferred embodiment of the assembly according to the invention in operation; and FIG. 3B is an exploded view of the third preferred embodiment of the assembly according to the invention according to FIG. 3A.

The same numerals in the shown figures designate the same components.

FIG. 1A is an isometric view of the first preferred embodiment of assembly 1 according to the invention during operation. Assembly 1 comprises a tassel 10 and a wall element 20. Assembly 1 is shown in operation, wherein tassel 10 is connected to control loop 3 and wall element 20 is fixed to a wall (not shown). Because tassel 10 can move in vertical direction relative to wall element 20, tassel 10 can tension the control loop 3 of a screen (not shown) with its own weight.

FIG. 1B is an exploded view of the first preferred embodiment of assembly 1 according to FIG. 1A. Tassel 10 is substantially constructed from a body 11 and control loop guide means 12 for the control loop. The control loop guide means 12 are connected to body 11 by means of known connecting techniques, such as a screw shown in FIG. 2. Wall element 20 and tassel 10 are configured to guide at least a part of body 11. Body 11 comprises for this purpose a guide slot 13 on the longitudinal side thereof, and wall element 20 is provided with four guide elements 21. After fixing of wall element 20 to the wall (not shown), tassel 10 can be attached to wall element 20 by sliding the body 11 in guide elements 21 by means of guide slot 13. A limiting element or base 14 is then connected to body 11, after which the control loop guide means 12 are arranged on body 11.

FIG. 2A is an isometric view of the second preferred embodiment of assembly 100 according to the invention in operation. Assembly 100 comprises a tassel 110 and a wall element 120. Assembly 100 is shown during operation, wherein tassel 110 is connected to control loop 3 and wall element 120 is fixed to a wall (not shown). Because tassel 110 can move in vertical direction relative to wall element 120, tassel 110 can tension control loop 3 of a screen (not shown) with its own weight.

FIG. 2B is an exploded view of the first preferred embodiment of the assembly according to the invention. Tassel 110 is substantially constructed from a body 111 and control loop guide means 112 for the control loop. The control loop guide means 112 are connected to body 111 by means of known connecting techniques, such as a screw shown in FIG. 2. Wall element 120 and tassel 110 are configured to guide at least a part of body 111. Wall element 120 is provided for this purpose with an opening 121. The peripheral shape of opening 121 corresponds to the peripheral shape of body 111. After fixing of wall element 120 to the wall (not shown), body 111 is slid into opening 121. A limiting element or base 113 is then connected to body 111, after which the control loop guide means 112 are arranged on body 111.

FIG. 3A is an isometric view of the third preferred embodiment of assembly 200 according to the invention in operation and FIG. 3B is an exploded view of assembly 200. Assembly 200 has many similarities to assembly 1 of FIGS. 1A and 1B. The reference numerals of corresponding components are increased by the number 200.

Wall element 220 and tassel 210 are configured to guide at least a part of body 211. Body 211 comprises for this purpose a guide slot 213 on the longitudinal side thereof and wall element 220 is provided with a guide element 221. As in the first preferred embodiment, the form of the guide element is adapted to the form of the guide slot. The guide slot comprises an opening and an adjacent cavity or recess lying in the interior of the tassel body. In the third preferred embodiment the guide element 221 is generally spherical and the cross-section of guide slot 213 is generally circular. In the first preferred embodiment the guide elements are protrusions 21 which are arranged on either side of a plate element forming part of the wall element, and the cross-section of guide slot 13 is T-shaped or cross-shaped.

When assembly 200 is supplied the tassel 210 has already been provided with the limiting element or base 214 and has preferably already been mounted on wall element 220. The assembled assembly has to be fixed to a wall and the control loop guide means 212 have to be arranged on body 211.

The shown preferred embodiment is provided with a chain tensioner 216 which operates by means of a spring 215 and which is optional.

The invention is expressly not limited to the shown embodiments. All combinations and kinematic reversals of the described technical measures fall expressly within the invention. It is therefore also possible for the guide slot to be arranged on the wall element, and one or more guide elements on the body. The body can also take a conical or tapering form. The cross-section of the body need not be round but can take other forms, such as square. The invention therefore extends to any embodiment falling within the scope of protection as defined in the claims and as seen in the light of the foregoing description and accompanying drawings.

1-11. (canceled)

12. Assembly (100, 200) of a tassel (110, 210) for tensioning a control loop (3) of a screen such as a window covering by means of gravitational force, comprising at least an elongate body (111, 211) and control loop guide means (112, 212) for the control loop (3), and a wall element (120, 220), this wall element being configured for fixing to a wall and intended for receiving the tassel (110, 210), wherein the tassel and the wall element are configured such that the tassel is enclosed by the wall element during operation and the tassel is substantially movable relative to the wall element, wherein the wall element (120, 220) contains one guide element (121, 221) for guiding at least a part of the body (111, 211), said guide element having a circular cross section.

13. Assembly (200) as claimed in claim 1, wherein the body (211) is provided on the longitudinal side thereof with a guide slot (213), wherein the guide slot (213) and the guide element (221) are configured for co-action.

14. Assembly (200) as claimed in claim 2, wherein the guide element (221) is a generally spherical protrusion.

15. Assembly (100) as claimed in claim 1, wherein the guide element of the wall element (120) is provided with an opening (121), the peripheral shape of which substantially corresponds at least partially to the peripheral shape of the body (111), wherein the body (111) is received in the opening (121) during operation of the assembly (100),.

16. Assembly (100) as claimed in claim 4, wherein the guide element is a ring.

17. Assembly (100, 200) as claimed in claim 1, wherein the tassel (110, 210) is provided with a limiting element (113, 214) which is formed such that during operation of the assembly (100, 200) the limiting element (113, 214) limits the movement of the tassel (110, 210) in the wall element (120, 220).

18. Assembly (100, 200) as claimed in claim 6, wherein the limiting element (113, 214) forms a base.

19. Assembly (100, 200) as claimed in claim 6, wherein the limiting element (113, 214) is releasably mountable on the tassel (110, 210).

20. Assembly (100, 200) as claimed in claim 2, wherein the guide slot (213) and/or the guide element (221) is/are provided with a sound-damping material.

21. Assembly (100, 200) as claimed in claim 1, wherein the control loop guide means (112, 212) are provided with a passage intended for throughfeed of the control loop (3) in a throughfeed direction, and wherein the angle between the throughfeed direction and the wall element (120, 220) is adjustable.

22. Assembly (100, 200) as claimed in claim 10, wherein the control loop guide means (112, 212) are rotatable relative to the body (111, 211).
